(19) United States
(12) Patent Application Publication
(10) Pub. No.: US 2006/0152067 A1
(43) Pub. Date: Jul. 13, 2006

(54) Wheel and a wheel disc

(76) Inventors: Claudio Corte, Limeira-SP (BR); Nelson Gosser, Piracicaba-SP (BR)

Correspondence Address: CARLSON, GASKEY & OLDS, P.C., 400 WEST MAPLE ROAD, SUITE 350, BIRMINGHAM, MI, 48009, US

(21) Appl. No.: 10/532,455

(22) PCT Filed: Oct. 9, 2003
(86) PCT No.: PCT/BR03/00146

§ 371 Date: Sep. 15, 2005

(30) Foreign Application Priority Data
Oct. 23, 2002 (BR) PI0204356-4

(51) Int. Cl. B60B 1/00

(52) U.S. Cl. 301/35.631

(57) ABSTRACT

A wheel for use on a vehicle includes a wheel rim and a wheel disc associable to each other. The wheel disc includes a central portion that has a region for accommodating a wheel hub of the vehicle. At least six fixing bores are concentrically arranged around the central portion. The fixing bores include a first set of bores that define a first circumference having a first diameter and a second set of bores that define a second circumference having a second diameter different from the first diameter. The wheel is associated to the wheel hub of the vehicle by direct association of at least three fixing elements with the first set of bores or the second set of bores.

### REFERENCE TO RELATED APPLICATIONS

The application claims priority to PCT Patent Application No. PCT/BR2003/000146 which was filed on Oct. 9, 2003, which claims priority to Brazilian Patent Application No. P10204356-4 which was filed on Oct. 23, 2002.

### BACKGROUND OF THE INVENTION

The present invention relates generally to a wheel, preferably a stamped wheel, including a wheel disc having multiple bores that enable the wheel disc to be fixed to wheel hubs of various vehicle models.

The present vehicle market is very competitive, which have caused mergers between large assembly plants to ensure greater competitiveness and a greater ability to withstand market pressures. As a result, companies try to minimize, as much as possible, their costs and to increase productivity. With regard to the wheels, it is preferable to use wheels from the same supplier and of the same model for several lines of vehicles.

Vehicles made in each assembly plant use different wheels. As already known, a wheel is formed by a rim and a disc, and the disc is provided with a central portion having at least three through bores for fixing the wheel to a wheel hub and a central bore. The bores are arranged concentrically around the central bore, but the diameter (of the circumference) formed from respective central points of the bores varies from assembly plant to assembly plant.

For example, FIAT and General Motors (GM) have recently associated with each other. For the FIAT, the diameter (of the circumference) from the central point of the through bores that fix the vehicle disc is 98 mm, and the wheel disc includes four bores. Vehicles from GM use wheels including four bores, and a diameter from the central point of the bores is 100 mm.

However, some models of these vehicles and models from other assembly companies use other boring configurations, which have other diameter values, as well as a different number of fixation bores.

To solve this problem, wheels have been developed that include a disc provided with a central portion having various boring configurations that have various diameters and various number of bores. These wheels include an adapter that overlaps the central portion of the wheel disc that positions and fixes the wheel to the vehicle hub according to project determinations. This type of wheel is disclosed in U.S. Pat. No. 3,166,357.

However, this wheel is stamped and has a reduced thickness at the central region of the disc, enabling it to be easily stamped. The resistance of the wheel fixed to the vehicle decreases since the through bores are very close to each other. When the wheel is fixed to the vehicle hub, it is subjected to a great tightening pressure and may be damaged at the (those) point(s) where pressure has been applied due to its thinness. In this case, a thicker adapter that cooperates with the existing thickness on the wheel disc has been used to solve this problem, increasing the final thickness of the assembly and distributing the load resulting from the tightening of the screws.

Brazilian documents PI 9204344-5 and PI 9300987-9 disclose light alloys cast wheels which employ the same concept of the wheel presented by U.S. Pat. No. 3,166,357. The bores in the central portion of the wheel disc extend radially, and the central portion receives, in an overlapped manner, an adapter disc provided with a variety of different bores that are compatible with a determined number of automobiles. The three documents cited above use adapters that increase the final cost of the wheel and makes it difficult to fix the wheel to the vehicle hub.

Brazilian Document PI 9203685-6 discloses a wheel made of a light alloy which includes a disc provided with a central portion having eight bores, forming two sets of four bores. Each set of bores includes four bores arranged concentrically to the central bore of the wheel disc, forming a circumference of a particular diameter. In this way, the bores have circumferences of different diameters. However, the wheels of light alloy are manufactured completely differently and are much more expensive. Therefore, these wheels do not originally equip economical and utility vehicles, which limits their penetration into the market and, consequently, their sales potential. For this reason, these wheels are not easily accessible because this type of wheel may be five times as expensive as the stamped-steel wheel.

The wheels made of light alloy are also more expensive because a material having a higher final cost, for example aluminum, is needed, and the machining of these materials consumes much electric energy. Also, to be casted, the wheel made of light alloy needs more manufacture material than steel wheels to provide additional more strength. All these additional costs are passed on to the final consumer, which greatly raises the cost of this type of wheel.

The wheel made of light alloy are made of a technically fragile material, that is, the material deforms very little and may break after being exposed to a determined strain. Wheels of steel deform and, consequently, may prevent an accident since they collapse to prevent an immediate leakage of air out of the tire, thus enabling a less skillful driver to control the vehicle. Wheels made of light alloy, on the contrary, may burst immediately.

There are other drawbacks to the stamped steel wheels of the prior art. When a consumer changes the vehicle and intends to use the wheels with a future vehicle, he often cannot use the wheels on the new vehicle. This occurs because the bore diameter of the wheel disc for fixing the wheel disc to the hub can be different from that of the preceding wheel if the vehicle model is different. Therefore, the consumer cannot continue to use the same wheels.

### SUMMARY OF THE INVENTION

An object of the present invention is to provide a wheel that is preferably stamped from steel that includes a wheel rim and a wheel disc associated to each other. The wheel disc includes a central portion having a central bore and at least two sets of fixing bores which are concentric to the central bore. Another objective of the invention it to provide a wheel disc configured as described above.

The objects of the present invention are achieved by a wheel, particularly for use on a vehicle, including a wheel rim and a wheel disc associable to each other. The wheel disc is provided with a central portion which includes a region for accommodating a wheel hub of the vehicle and around which at least six fixing bores are arranged. The fixing bores configure at least a first set of bores that define a first circumference having a first diameter and a second set of bores that define a second circumference having a second diameter different from the first diameter. The wheel is associated to the wheel hub of the vehicle by direct association of at least three fixing elements with the first set of bores or the second set of bores and through the respective fixing bores.

Also, the objectives of the present invention are achieved by a wheel disc, particularly associable to a wheel rim, that forms a wheel for use on a vehicle. The wheel includes a central portion having a region for accommodating the wheel of the vehicle and around which at least six fixing bores are arranged. The fixing bores configure at least a first set of bores that define a first circumference having a first diameter and a second set of bores that define a second circumference having a second diameter different from the first diameter. The disc is directly associable to the wheel hub of the vehicle by direct association of at least three fixing elements with the first set of bores or the second set of bores and through the respective fixing bores.

The present invention has many advantages. For one, the area of the assembly cells in the assembling plant decreases because there are fewer types of wheels to be assembled, increasing the amount of space of the assembling plant. Additionally, logistic are easier due to the decrease in the variety of wheels produced. Finally, the cost of wheel-manufacture is reduced due to the economies of scale.

### BRIEF DESCRIPTION OF THE FIGURES

The present invention will now be described in greater detail with reference to the embodiments presented in the drawings. The figures show:

FIG. 1 shows a detail view of a central portion of a wheel disc of a first embodiment of a stamped wheel of the prior art;

FIG. 2 shows a schematic detail view of the central portion of the wheel disc of the first embodiment of the stamped wheel of the prior art;

FIG. 3 shows a detail view of the central portion of the wheel disc of a second embodiment of the stamped wheel of the prior art;

FIG. 4 shows a schematic detail view of the central portion of the wheel disc of a second embodiment of a wheel of the prior art;

FIG. 5 shows a front view of a first embodiment of the wheel according to the present invention;

FIG. 6 shows a schematic view of the central portion of the wheel disc of the first embodiment of the wheel according to the present invention;

FIG. 7 shows a detail view of the central portion of the wheel disc of a second embodiment of the wheel according to the present invention; and

FIG. 8 shows a detail view of the central portion of the wheel disc of a third embodiment of the wheel according to the present invention.

### DETAILED DESCRIPTION OF THE PREFERRED EMBODIMENT

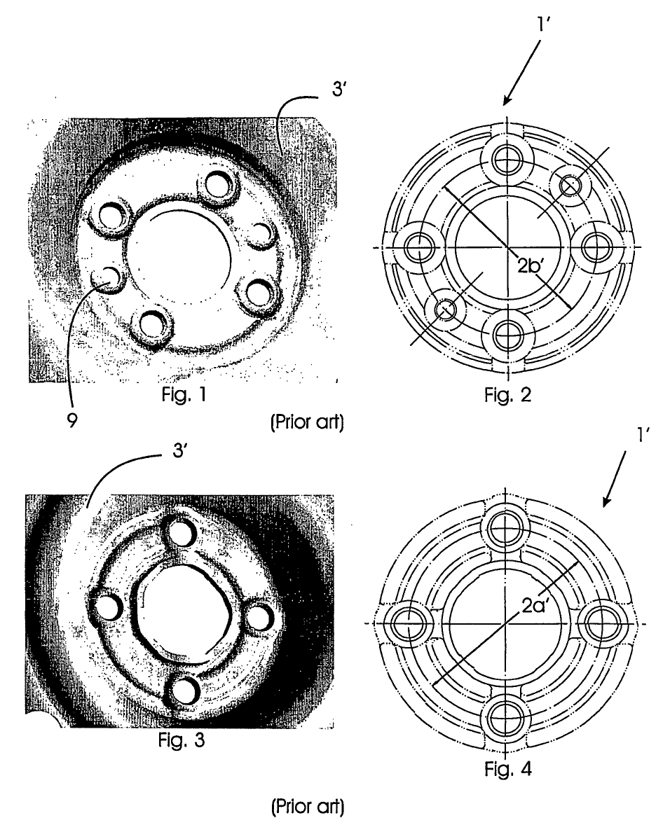

As shown in FIGS. 1 to 4, stamped wheels of the prior art are configured specifically for the vehicles of each assembly plant. Each stamped wheel includes a central bore 1′ of a wheel disc 3′ having a diameter 2a′ or 2b′ (which-will be explained in greater detail below) which depends on the type of vehicle on which the wheel will be used.

Each set of bores includes at least three fixing through-bores, which may vary from four, five, six to ten bores. The set of bores for the vehicles in each assembly plant may have different diameters.

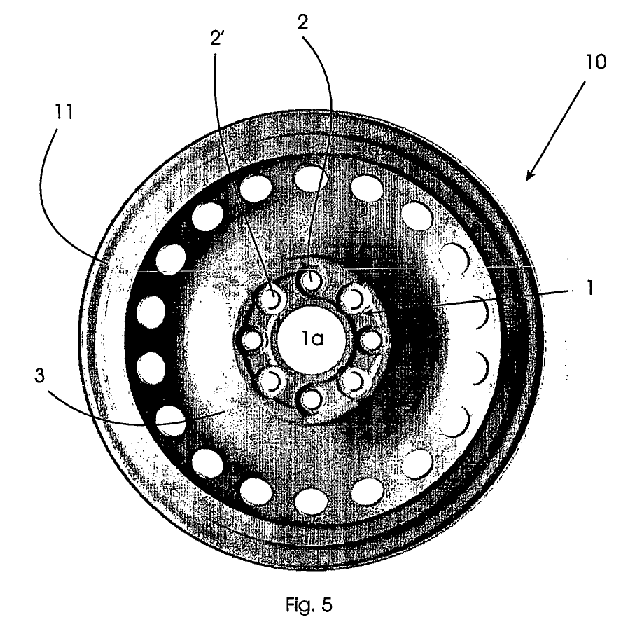

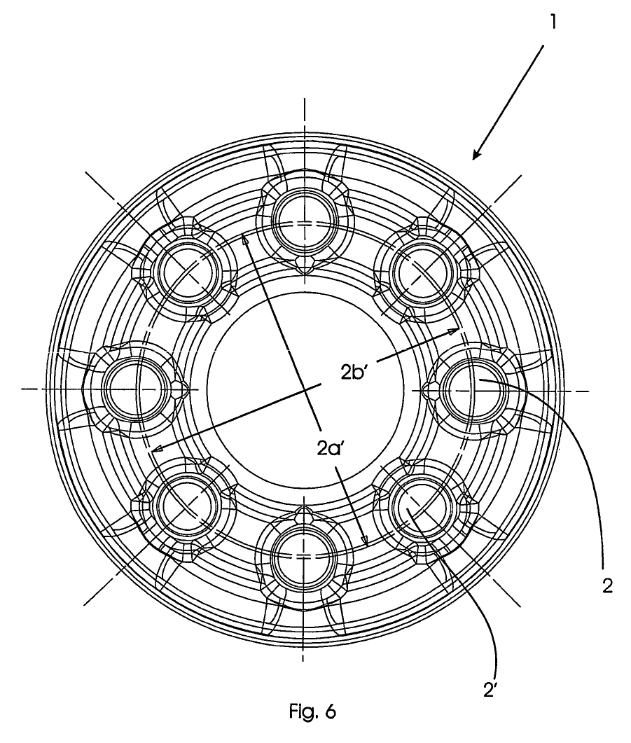

According to a preferred embodiment shown in FIG. 5, the present invention includes a wheel 10, preferably stamped from steel, which has a substantially cylindrical wheel rim 11 and a substantially circular wheel disc 3. The wheel disc 3 and the wheel rim 11 are associated to each other, preferably by welding, but any other means may be used.

The wheel disc 3 includes a substantially circular central portion 1 that defines a region for accommodating a wheel hub. Preferably, the accommodating region configures a central bore 1a, which may be a projection facing outwardly that defines a cavity for accommodating a tip of an axle or have any other configuration. At least six fixing through-bores 2 and 2′ are concentrically arranged around the accommodating region. Preferably, the bores 2 and 2′ are located in the central portion 1, but the bores 2 and 2′ can be located more outwardly and closer to the wheel rim 11 on some wheels. The bores 2 and 2′ are always concentric, and the bores 2 and 2′ are preferably formed during the process of stamping the wheel, but they may be made by any other manufacturing processes.

The bores 2 and 2′ are arranged around the central bore 1a, or an equivalent one, configuring at least a first set of bores and a second set of bores that define two imaginary circumferences with different concentric diameters 2a and 2b. Preferably, each set of bores is formed by four different bores 2 and 2′ having first and second diameters 2a and 2b, preferably of 100 mm and 98 mm, respectively. The number of bores in each set of bores may vary depending upon the number of fixing means existing on the wheel hub, as for example fixing screws or studs, which will fix the wheel to the wheel hub through the bores 2 and 2′.

As already mentioned, each set of bores 2 and 2′ has a diameter 2a or 2b that is different from the diameter of the other set of bores, so that the wheel 10 can be used on vehicles having a wheel hub with different diameters.

Thus, if the user buys a set of wheels 10 according to the present invention for his vehicle, but intends to change the vehicle within a given period of time and wishes to keep the wheels 10, he may use the wheels 10 on the new vehicle since the wheels 10 have two sets of bores 2 and 2′ with different diameters 2a and 2b, providing there is compatibility with regard to the number of bores 2 and 2′ and the diameters 2a and 2b.

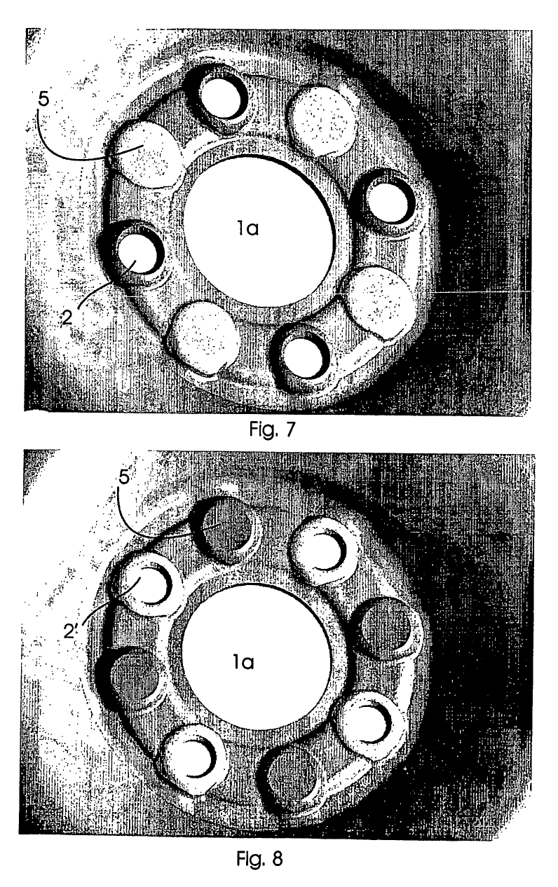

Following the same concept, a second and a third preferred embodiments of the present invention are shown in FIGS. 7 and 8, respectively. In these embodiments of the wheel 10, the bores 2 and 2′ of one set of bores are open and the bores 2 and 2′ of the other set of bores are closed with covers 5, which may preferably be removed if they are used on another vehicle. This embodiment of the present wheel 10 equips vehicles as an original component from the factory. The covers 5 also help the user to remove/replace the wheel 10 onto the vehicle during maintenance, since the four bores 2 and 2′ that he will use are uncovered, and the four other bores 2 and 2′ remain hidden, preventing the wheel 10 from being wrongly assembled and preventing confusion. Further, if the user decides to use the wheel 10 on a vehicle compatible with the set of bores 2 and 2′ stamped in it, he may reposition the covers 5 as needed. The covers 5 are preferably secured by pressure, but they may be fixed onto the wheel 10 by any other means.

In the example of the GM/HAT vehicles, the solution of using different sets of bores 2 and 2′ for the vehicles from the two assembly plants is possible. The FIAT vehicles have a 98 mm (millimeters) diameter configuration of the bores around the central portion 1 of the wheel disc 3, and the GM vehicles have a 100 mm (millimeters) configuration, which are defined by the respective factory projects. A single model of wheel 10 can be purchased and both the vehicles can be equipped with a wheel 10 provided with two bore 2 and 2′ configurations. The vehicle has wheels 10 with a set of bores for the FIAT vehicle and a hidden set of bores for the GM vehicles, thus providing an economy of scale.

The wheel hub can include a guiding pin to help position the wheel 10, and the guiding pin fits into a bore 9 existing in the adequate or compatible wheels from the prior art. The guiding pin can be accommodated in one of the bores 2 and 2′ of the other set of bores in the wheel 10.

As already mentioned, large companies have various vehicles in their production lines, and the wheels 10 of the present invention makes it possible to provide different bore diameters 2a and 2b with two or more sets of bores 2 and 2′, but concordant with the vehicles of the company. This provides economies of scale, rapid production, a reduced numbers of processes for manufacturing the various models of wheel, and a reduced stock.

Another advantage for these companies is the optimization of assembly cells, which include a small assembly line within a general vehicle-production line. The vehicle assembly company provides a wheel supplier a space within the factory. The wheel supplier is associated with the tire supplier and, in a joint process, they make a wheel-tire assembly available which is already assembled, balanced, calibrated and ready for mounting onto the vehicle. This reduces the number of issues relating to assembly.

The wheel 10 of the present invention provides many advantages for the vehicle assembly company and for the supplying company. For one, the area of the assembly cells is reduced because there are a fewer number of different types of wheels, increasing the useful space of the assembly plant. Additionally, the assembly plant has fewer concerns about delivery mistakes and with the type of wheel received, because the wheel may be used on various models of vehicle. The wheel supplier only needs to fulfill one shipment of wheels 10 for various assembly plants without worring about separating various types of wheels, saving on transport for the various models that would have to be delivered, therefore reducing work. As already mentioned, because only one type of wheel 10 is being delivered, there is a reduction in delivery mistakes because only one type of wheel 10 is provided. Therefore, the wheel supplier can focus on the number of orders from each assembly plant. The cost of manufacturing the wheel 10 is also reduced because of economies of scale.

To fix the wheel 10 onto the wheel hub of the vehicle, the wheel is positioned with the set of bores that are adequate for the vehicle involved and the screws or other fixing elements are tightened. There is no need for using any type of adapter or any other additional element, and the procedure is identical to the procedure used in the case of the conventional wheel. The fixing elements associate the wheel directly with the wheel hub without needing adapters or other elements.

A preferred embodiment of the invention having been described, one should understand that the scope of the present invention embraces other possible variations, being limited only by the contents of the accompanying claims, which include the possible equivalents.

These and other features of the present invention can be best understood from the following specification and drawings, the following of which is a brief description. Although a preferred embodiment of this invention has been disclosed, a worker of ordinary skill in this art would recognize that certain modifications would come within the scope of this invention. For that reason, the following claims should be studied to determine the true scope and content of this invention.

The foregoing description is only exemplary of the principles of the invention. Many modifications and variations are possible in light of the above teachings. It is, therefore, to be understood that within the scope of the appended claims, the invention may be practiced otherwise than using the example embodiments which have been specifically described. For that reason the following claims should be studied to determine the true scope and content of this invention.

1. A wheel for a vehicle comprising
a wheel rim; and
a wheel disc associable to the wheel rim, the wheel disc including:
a central portion that includes a region for accommodating a wheel hub of the vehicle, and
at least six fixing bores concentrically arranged around the central portion, wherein the at least six fixing bores include a first set of bores defining a first circumference having a first diameter and a second set of bores defining a second circumference having a second diameter different from the first diameter,
wherein the wheel is associated to the wheel hub of the vehicle by direct association of at least three fixing elements with one of the first set of bores and the second set of bores and through bores of the one of the first set of bores and the second set of bores.

2. The wheel according to claim 1, wherein the at least six fixing bores comprises eight fixing bores.

3. (canceled)

4. The wheel according to claim 23, wherein each of the first set of bores and the second set of bores comprise four bores.

5. The wheel according to claim 1, wherein the region for accommodating the wheel hub is a central bore.

6. The wheel according to claim 1, wherein the at least six fixing bores are arranged around the central portion.

7. The wheel according to claim 1, wherein the first diameter of the first circumference is approximately 100 mm.

8. The wheel according to claim 7, wherein the second diameter of the second circumference is approximately 98 mm.

9. The wheel according to claim 1, wherein each of the bores of the first set of bores is covered with a covers.

10. The wheel according to claim 1, wherein each of the bores of the second set of bores is covered with a cover.

11. The wheel according to claim 1, wherein the wheel disc is formed by stamping.

12. The wheel according to claim 11, wherein the at least six fixing bores are formed during stamping the wheel discs.

13. A wheel disc associable to a wheel rim forming a wheel for use on a vehicle comprising:
a central portion;
a region for accommodating a wheel hub of the vehicle; and
at least six fixing bores concentrically arranged around the region, wherein the at least six fixing bores include a first set of bores that define a first circumference having a first diameter and a second set of bores that define a second circumference having a second diameter different from the first diameter,
wherein the wheel disc is directly associable to a wheel hub of the vehicle by direct association of at least three fixing elements with one of the first set of bores and the second set of bores and through bores of the one of the first set of bores and the second set of bores.

14. The disc according to claim 13, wherein the at least six fixing bores comprises eight fixing bores.

15. (canceled)

16. The disc according to claim 14, wherein each of the first set of bores and the second set of bores comprise four bores.

17. The disc according to claim 13, wherein the region for accommodating the wheel hub is a central bore.

18. The disc according to claim 13, wherein the at least six fixing bores are arranged in the central portion.

19. The disc according to claim 13, wherein the first diameters of the first circumference is approximately 100 mm.

20. The disc according to claim 19, wherein the second diameter of the second circumference is approximately 98 mm.

21. The disc according to claim 13, wherein each of the bores of the first set of bores is covered with a cover.

22. The disc according to claim 13, wherein each of the bores of the second set of bores is covered with a cover.

23. The disc according to claim 13, wherein the disc is formed by stamping.

24. The disc according to claim 23, wherein the at least six fixing bores are formed during stamping of the wheel disc.
